(19) United States
(12) Patent Application Publication
(10) Pub. No.: US 2005/0157746 A1
(43) Pub. Date: Jul. 21, 2005

(54) Portable apparatus for providing a computer data and/or computer data program to a mobile computerized electronic device, and associated method

(75) Inventor: Oyvind Horpestad, Haugesund (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: CellJump Ltd., Luton (GB)

(21) Appl. No.: 11/033,613

(22) Filed: Jan. 12, 2005

Related U.S. Application Data
(60) Provisional application No. 60/537,164, filed on Jan. 16, 2004.

(51) Int. Cl. H04L 12/66

(52) U.S. Cl. 370/463

(57) ABSTRACT

A portable electronic apparatus for providing computer data or a computer program to a mobile computerized device, and an associated method, is provided. A portable apparatus of the invention comprises an interface means adapted to an interface of a mobile device and adapted to sense at least one input, a memory means carrying thereon a computer data or computer program intended for the mobile device, a control means responsive to an input to the interface means and a data communication means arranged to communicating at least part of the computer data or computer program over the interface means in response to control input from the control means. A method for providing a portable electronic apparatus for providing computer data or a computer program to a mobile computerized device includes steps for carrying out the functions of the various means of an apparatus according to the invention.

### CROSS REFERENCE TO RELATED APPLICATION

This application claims priority from U.S. Provisional Patent Application No. 60/537,164, filed on Jan. 16, 2004, which is incorporated by reference as if fully set forth.

### FIELD OF INVENTION

The present invention relates to the field of mobile electronic technology, particularly to an apparatus and method for providing a computer data or a computer program to a mobile electronic device having a data processor.

### BACKGROUND

Present day mobile electronic devices, such as mobile telephones, personal digital assistants (PDA), portable personal computers (PPC), handheld navigational receivers for the global positioning system (GPS) or LORAN, advanced wireless remote control devices, and the light, are typically equipped with a data processor and a computer application program to run on the data processor for controlling the operation of the mobile electronic device. Such devices, to an ever increasing extent, also include various interfaces to allow interaction with the operation of the device, or for inputting or modification of operational parameters that affect the operational device, or even extended memory capability for downloading to the device additional computer programs that may run on the data processor to provide to the user additional services and capabilities beyond what is delivered as these standard features of the device. Over time, the possibilities for inputting or transferring data, commands, parameters or programs to such devices have steadily been improved, from relying on manual input by a users keyboard entry on the device itself, to wireless downloading through an optical or radio frequency network from a remote server by the user's touch of a signal button, or even by the input of a simple speech command from the user. Although the present day technology has become quite advanced, there are still a number of problems related to the supply of a computer data or a computer application program to a mobile electronic device to make it practicable and commercially viable for the user of the device, as well as for the provide of any such computer data or computer program.

### SUMMARY

In a typical example of a present day mobile electronic device, such as a mobile telephone or a PDA, additional data or programs may be introduced to the device by establishing a network connection to a server, by performing a logging procedure to the server, and then by selecting and specifying the data or computer program item to be received by the device, whereupon a transfer procedure is initiated and completed, followed by server log-off and network disconnecting procedures.

In another example, the aforementioned mobile telephone or PDA may be provided with additional computer data or computer program by way of a standard memory card, which is connected to a standard memory card connector interface provided on a mobile device, whereupon a user by browsing the contents of the memory device can select a computer data or computer program item of interest and initiate a procedure for copying the computer data or computer program item of interest to the electronics of the mobile device.

As will be understood, to present day arrangements and methods for providing such additional data and features to a mobile electronic device require additional interfaces and procedures beyond the standard provisions of a simpler mobile electronic device to facilitate the provision of such additional computer data and computer programs to the device. Furthermore, are such present day solutions are cumbersome to operate for the user, and do only to a limited extent address concerns of the provider of supplementary computer data or computer programs to control or protect the use and distribution of such items.

A simpler, more cost effective, more user and provider friendly solution is provided by the present invention, by the portable electronic apparatus for providing a computer data or a computer program to a mobile computerized device according to the accompanying independent patent claim 1, and the method for providing a portable electronic apparatus for providing a computer data or a computer program to a mobile computerized device according to the accompanying independent method claim 24.

Further advantageous features of the portable electronic apparatus of the invention are according to the accompanying dependent patent claims 2-23.

Further advantageous features of the method of the invention are according to the dependent method claims 24 through 39.

### BRIEF DESCRIPTION OF THE DRAWINGS

In the following, the present invention will be explained by way of examples and by reference to the accompanying drawings, where:

FIG. 1 is a simplified electrical schematic diagram of the electronics part of a portable apparatus according to the invention, and

FIG. 2 is a schematic exemplary flow diagram of a procedure in an exemplary embodiment of the present invention for initiating, controlling and completing information transfer from a portable apparatus according to the invention to a mobile electronic device.

### DETAILED DESCRIPTION OF THE PREFERRED EMBODIMENTS

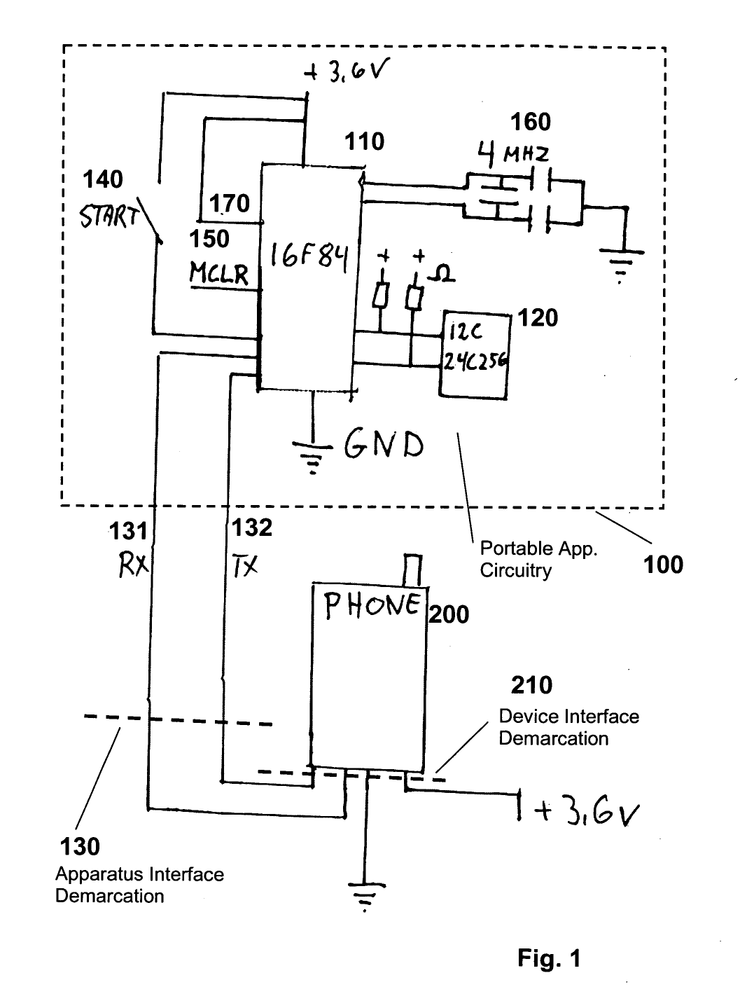

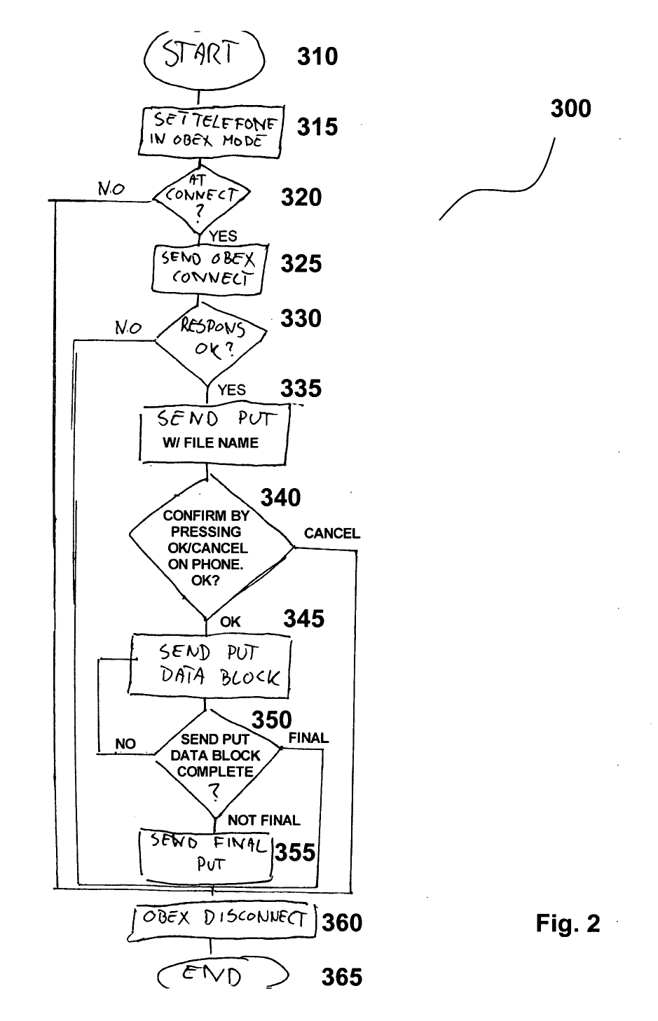

In a first embodiment of the invention, the portable apparatus comprises a programmable memory and a microcontroller in a self-contained unit, and connected to an interface connector as part of said unit. The interface connector is adapted to an ordinary interface connector of the mobile device to which it is adapted, such as for example the standard interface connector of a mobile telephone. The programmable memory includes a program part for operation of the microcontroller and another part that holds a data or a computer program item to be copied to a memory device of the mobile electronic device. Power for the electronic elements of the portable apparatus is provided by a power source of the mobile electronic device, as shown in the example of FIG. 2 with the reference +3.6V. Accordingly, in one embodiment of the invention, the portable apparatus needs not carry an electrical power source, but could, as an option to receiving electric power via the interface connector carry its own power source in form of a primary cell battery or a rechargeable battery. In the embodiment represented by the circuit schematic of FIG. 1, the apparatus interface demarcation 130 indicates the electrical interface of the apparatus, which in the embodiment shown include lines for transmission and receiving data. Depending on the capabilities of the mobile electronic device 200, the receive line 131 may be omitted if no input from the mobile device 200 in form of a data stream is required for the operation of the portable apparatus 100 according to this embodiment. In the embodiment shown in FIG. 1, the portable apparatus circuitry comprises a microcontroller 110, a memory circuit 120, a circuit switch 140, and an oscillator circuit 160 serving as a clock timing generator for the microcontroller 110, and a memory circuit 120. Optionally, the circuitry includes a memory clear input 150 for the microcontroller 110, to control the state of an internal memory of the microcontroller 110, or the state of the external memory circuit 120. A more detailed explanation of the use and purpose of the memory control input 150 is to follow.

To operate the portable apparatus 100 as shown in the embodiment of FIG. 1, after connecting the portable apparatus 100 to a mobile telephone 200, the user will press a button of a start switch 140 to initiate the operation of the microcontroller 110 according to program instructions stored in the memory circuit 120. In a simple embodiment of the present invention, the program for operating the microcontroller 110 will initiate a sequence to make the processor device of the mobile phone 200 aware of the existence of the portable apparatus 100, and carry out any sequence required to transfer a computer data or a computer program stored in a memory circuit 120 across the apparatus interface 130 and the mobile device interface 210, and to complete the sequence by notifying the processor of the mobile phone 200 that a transfer has been completed. As part of a notification of a completion of the transfer, the microcontroller 110 according to the operating program stored in the memory device 120 may provide instructions to the mobile telephone 200 to assume a state of operation wherein the processor device of the mobile telephone 200 initiate processing of a transferred program or the use of a transferred computer data item. As an example, a computer data item may comprise a logo to be shown on the display of the mobile phone 200, or a playable sound item to signal to the user an incoming call. As an example of a computer program item transferred by way of the portable apparatus of the invention, is a new computer game program executable on the microprocessor of the mobile telephone 200.

As an alternative to, or in lieu of the start switch 140, the microcontroller 110 of the portable apparatus 100 of the invention is provided with an input 170 to the microcontroller to monitor a voltage supplied to the portable apparatus 100 according to the invention. By its detection of an appropriate voltage on the input 170, the microcontroller 110 will initiate an execution of an operating program stored in the memory device 120, or, optionally, the execution of an operating program preprogrammed and stored in a memory device of the microcontroller 110 itself. The detection of an appropriate voltage on the input 170 could then, in one embodiment of the invention, initiate the procedure 300 as shown in FIG. 2.

In one aspect of the invention, the portable electronic apparatus of the invention includes an indicator means in communication with a control means, said control means in an embodiment represented by the microcontroller 110, for indicating a usage state of the memory means 120. The usage state may include a specification of at least a part of computer data or a computer program that has been communicated via the interface 130 to the mobile device 200, a count of the number of times at least part of the computer data or computer program held in the memory device 120 were communicated via the interface 130, or a time of usage comprising at least one of a time of day or date, or a period of operation. By monitoring the usage of the apparatus, a part of the operating program of the microcontroller 110 may monitor the usage, compare the usage to a predefined reference, and initiate a preprogrammed action in dependence of the usage information and the preprogrammed reference. As an example, in one embodiment of the invention, the microcontroller will by way of a modification of its own operating parameters or operating program, or by way of instructions to the memory circuit 120 or a circuit associated with a memory circuit, facilitate a limitation on which parts of the contents of the memory device 120 may be transferred over the apparatus interface 130. Optionally, the operating program of the microcontroller 110 could include instructions which in dependence of the usage level recorded of the portable apparatus 100, produce instructions to raise or delete at least part of the contents of the memory circuit 120, or in a permanent, or semi-permanent way reprogram or modify circuitry associated with the memory circuit 120, which will limit access to at least part of the contents of the memory circuit 120. As an example, one embodiment of the invention includes a memory circuit 120, which holds a limited edition computer game, to which the user of the portable apparatus 100 has purchased a single use license, which after the completion of one transfer procedure of the computer program across the apparatus interface 130 will block any further attempts to transfer the computer program that originally were made available from the memory circuit 120.

In another embodiment of the invention, the computer data included in the memory circuit 120 comprises computer instructions to the processor of the mobile telephone 200 to dial a specific number for establishing a connection to a remote server, as well as data representing a security key or password, which will allow a transfer of a computer data or a computer program from the server to the mobile telephone 200 on the condition that the mobile telephone presents to the server the security key or password provided by the portable apparatus 100. Again, in one embodiment of the invention, the portable apparatus is adapted to restrict any further access to the security key or password after a successful transfer of the security key or password through the apparatus interface 130. To further strengthen a requirement for security, in one embodiment of the invention, the portable apparatus 100 will include a memory circuit 120 and a controller 110 capable of executing a security procedure comprising encryption and/or decryption of the security key or password, or an encryption or decryption of a computer data or computer program received by the telephone from an external server or other device for providing such information to the mobile telephone 200.

In yet another aspect of the present invention, the portable electronics apparatus of the invention includes a memory means for receiving and storing information provided by the mobile electronic device 200. In a preferred embodiment of the invention, the portable apparatus 100 includes a device or instructions to the microcontroller 110 to compare information previously stored in the third memory with information currently received via the apparatus interface 130, and on basis of the previously stored information and the current information received decide whether or not the mobile electronic device currently connected to the portable apparatus 100 should be given access to the information stored in the first memory device 120. As an example, the information received and stored could include an identifier of the mobile electronic device, such as an international mobile equipment identity (IMEI) typically available from a cellular telephone operating according to the global system for mobile communication (GSM) standard. Similar identification checks are considered for other types of identifications that may be preprogrammed into other devices such as a PDA or a portable personal computer or a portable navigation device operating in conjunction with the global positioning system (GPS).

In an advantageous embodiment of the invention, the portable apparatus 100 includes a usage indicator by which a user at a glance may determine whether or not the apparatus still may be useful. In one embodiment, the indicator includes a memory arrangement of a type that visually and permanently shows to the user the user stage of the portable apparatus. The indication could be by way of a fusible color indicator initially showing a green or other color to indicate that the device has not been used, and by the input of an electrical pulse changing the state of the indicator to a color, such as red, orange or black, to indicate to the user that no further data or program of interest to a user may be transferred from the device over the interface 130. An alternative to providing a physical element by the portable apparatus 100 to indicate the usage status of the portable apparatus 100, is in one embodiment of the invention the portable apparatus 100 adapted to transferring to the mobile electronic device 200 data and/or instructions to the processing device of the mobile electronic device 200 to utilize means of indicating provided by the mobile electronic device 200, such as a display, to provide to a user usage information. Such usage information could, as an example, include a directory of computer data items or computer program items stored in the memory device 120 of the portable apparatus 100 that are available for transfer to the mobile electronic device 200 across the apparatus interface 130.

In an advantageous embodiment of the invention, at least part of the electronic memory provided by the portable apparatus 100 is accessible for writing by the mobile electronic device 200, such that the mobile electronic device 200 can use memory provided by the portable apparatus 100 for storing information which later may be retrieved by the mobile electronic device 200.

In yet another embodiment of the present invention, the portable apparatus 100 includes a start switch 140 operationally associated with a mechanical interface of the apparatus interface 130, such that the start switch is actuated by physically connecting the portable apparatus 100 to a corresponding physical interface 210 of the mobile electronic device 200.

In yet another aspect of the present invention, an advantageous embodiment of the invention includes a time measuring device, or a memory for storing time information, to allow or limit access to the computer data or computer program to a specific date and time of day, to a specific period of usage, or to a period related to the time during which the portable apparatus 100 has made contact with the mobile electronic device 200.

In yet another advantageous embodiment of the invention, the control device 110 of the portable apparatus 100 is adapted to limit access to the computer data or computer program stored in the associated memory device 120 on basis of information obtainable across the apparatus interface 130 from the mobile electronic device 200, such as the operator of a mobile telephone network with which the mobile telephone 200 currently is registered, or on basis of information with respect to the geographical area in which the portable apparatus 100 currently is located.

In yet another advantageous aspect of the present invention, the portable apparatus 100 provided in an apparatus interface 130 of a wireless type, such as an optical or radio frequency interface, i.e. an infrared data association (IRDA) interface or a Bluetooth interface, respectively. Using a wireless interface for communicating with the mobile electronic device 200 will further simplify operation of the device, and allows for a physically more rugged and convenient embodiment of the invention.

In yet a further advantageous embodiment of the invention, the control circuit 110 of the portable apparatus 100 is adapted to, on basis of instructions provided by internal operating program, request from the mobile electronic devise 200 configuration data of interest, such as a language specified by the user of the mobile electronic devise 200. On basis of such information, the portable apparatus 100 will select the appropriate computer data or computer program for subsequent transfer to the mobile electronic device 200.

Advantageously, the present invention provides an apparatus and a method for simple, cost effective and secure provision of a computer data or a computer program to a mobile electronic devise. The portable apparatus 100 includes a memory means program with a computer data or a computer program of interest, wherein the computer data or computer program may include instructions for controlling the mobile electronic device to create a connection to remote server for downloading a data or program item from the remote server, or the downloading of a key or password and/or associated algorithm for subsequent loading of a data or program item from the portable apparatus.

1. A portable electronic apparatus for providing a computer data or a computer program to a mobile computerized device, said computer data or computer program representing a means for operating the device to provide an information or service different from a standard information or service of said device, wherein said portable apparatus comprises:
an interface means adapted to at least a mechanical, electrical or wireless interface and a data communications interface of the mobile computerized device, said interface means being different from a standard memory card interface means and adapted to sensing at least one interface means input;
a first programmable memory means carrying thereon a computer data or computer program, said computer data or computer program being adapted for utilization by the mobile computerized device;
a control means in communication with the interface means and adapted to processing said computer data or computer program in response to said at least one interface means input or an input from a separate input means; and
an electronic data communications means in communication with said control means and adapted to communicating at least part of said computer data or computer program to said interface means in response to a control input from said control means, said control input associated with said processing.

2. The portable electronic apparatus of claim 1, comprising:
an indicator means in communication with said control means for indicating a usage state of said programmable memory means.

3. The portable electronic apparatus of claim 1, comprising:
a second memory means for recording usage information.

4. The portable electronic apparatus of claim 3, wherein the second memory means is part of said first memory means.

5. The portable electronic apparatus of claim 3, wherein the control means is adapted to restrict, in response to said usage information, said communication of at least part of said computer data or computer program from said first memory to said interface means.

6. The portable electronic apparatus of claim 3, wherein the control means is adapted to reprogramming said first memory in response to said usage information.

7. The portable electronic apparatus of claim 6, wherein said reprogramming includes deleting at least part of said computer data or computer program or reprogramming an access means of said first memory means for restricting access to at least part of said computer data or computer program.

8. The portable electronic apparatus of claims 3, wherein said usage information includes at least one of:
a specification of said at least part of said computer data or computer program communicated to said interface means,
a count of the number of times said at least part of said computer data or computer program were communicated to said interface means, and
a time of usage comprising at least one of a time of day or a period of operation.

9. The portable electronic apparatus of claim 1, comprising a means for detecting a type of said computer data or computer program and wherein the control means is responsive to said type.

10. The portable electronic apparatus of claim 9, wherein said type is at least one of a mobile computerized device computer instruction, a game program, an image, a data or instruction for generating an audible signal, a dial instruction, a security key, a credit value, an account number, a password, a data processing procedure, a data communications procedure, a data converting procedure, and an encryption- or decryption procedure.

11. The portable electronic apparatus of claim 1, wherein the control means is programmable and responsive to a control instruction received via said interface means.

12. The portable electronic apparatus of claim 3, comprising:
a third memory means in communication with said control means for storing a first information received via said interface means.

13. The portable electronic apparatus of claim 12, wherein the third memory means is part of said first memory means.

14. The portable electronic apparatus of claim 12, wherein the control means is adapted to restricting, in response to said stored first information and a corresponding second information received via said interface means being different from said first information, said communication of said at least part of computer data or computer program from said first memory to said interface means.

15. The portable electronic apparatus of claim 12, wherein the control means is adapted to reprogramming said first memory in response to said stored first information and a corresponding second information received via said interface means.

16. The portable electronic apparatus of claim 15, wherein said reprogramming includes deleting at least part of said computer data or computer program or reprogramming an access means of said first memory for restricting access to at least part of said computer data or computer program.

17. The portable electronic apparatus of claim 12, wherein said first information includes an identification of a first of said mobile computerized device and said second information includes an identification of another of said mobile computerized device.

18. The portable electronic apparatus of claim 1, wherein said control means is adapted to requesting and receiving from said mobile computerized device, via said interface means, at least one of a configuration information and an operational information related to said mobile computerized device or an operation thereof.

19. The portable electronic apparatus of claim 18, wherein said control means is adapted to selectively controlling said communication of said at least part of said computer data or computer program to said mobile computerized device on basis of said at least one of a configuration information and an operational information.

20. The portable electronic apparatus of claim 18, wherein said at least one of a configuration information and an operational information includes at least one of a mobile computerized device type, model, identity geographic location, operational status, external communication type, external communication parameter, an external communications subscription type and an external communications provider.

21. The portable electronic apparatus of claim 1, wherein said mobile computerized device is a cellular telephone, a personal digital assistant (PDA) or a portable personal computer.

22. The portable electronic apparatus of claim 21, wherein said mobile computerized device includes an information item including an electronic representation of at least one of a mobile computerized device type, model, identity, geographic location, operational status, external communication type, external communication parameter, an external communications subscription type and an external communications provider, and said information item communicable via an interface of said mobile computerized device corresponding to said interface means.

23. The portable electronic apparatus of claim 22, wherein said electronic representation of an identity is an IMEI (International Mobile Equipment Identity) of a cellular telephone.

24. A method for providing a portable electronic apparatus for providing a computer data or a computer program to a mobile computerized device, said computer data or computer program representing a means for operating the device to provide an information or service different from a standard information or service of said device, wherein said method comprising:
providing an interface means adapted to at least a mechanical, electrical or wireless interface and a data communications interface of the mobile computerized device, said interface means different from a standard memory card interface means and said interface means adapted to sensing at least one interface means input;
providing a first programmable memory carrying thereon a computer data or computer program, said computer data or computer program adapted for utilization by the mobile computerized device;
providing a control means in communication with the interface means and adapted to processing said computer data or computer program in response to said at least one interface means input or an input from a separate input means;
providing an electronic data communications means in communication with said control means;
communicating under the control of said control means at least part of said computer data or computer program to said interface means in response to a control input from said control means, said control input associated with said processing;
providing a second memory means and recording apparatus related usage information in said second memory means;
providing an apparatus indicator means in communication with said control means for indicating a usage state of said programmable memory means; and
operating said apparatus indicator means to indicate a usage of said apparatus.

25. The method of claim 24, wherein the second memory means is part of said first memory means.

26. The method of claim 24, comprising:
restricting, in response to said usage information, said communication of at least part of said computer data or computer program from said first memory to said interface means.

27. The method of claim 24, comprising:
reprogramming said first memory in response to said usage information.

28. The method of claim 27, wherein said reprogramming includes deleting at least part of said computer data or computer program or reprogramming an access means of said first memory means for restricting access to at least part of said computer data or computer program.

29. The method of claim 24, wherein said usage information includes at least one of:
a specification of said at least part of said computer data or computer program communicated to said interface means;
a count of the number of times said at least part of said computer data or computer program were communicated to said interface means; and
a time of usage comprising at least one of a time of day or a period of operation.

30. The method of claim 24, comprising:
providing a third memory means in communication with said control means for storing a first information received via said interface means,
restricting, in response to said stored first information and a corresponding second information received via said interface means being different from said first information, said communication of said at least part of computer data or computer program from said first memory to said interface means.

31. The method of claim 30, comprising reprogramming said first memory in response to said stored first information and a corresponding second information received via said interface means.

32. The method of claim 31, wherein said reprogramming includes deleting at least part of said computer data or computer program or reprogramming an access means of said first memory for restricting access to at least part of said computer data or computer program.

33. The method of claim 30, wherein said first information includes an identification of a first of said mobile computerized device and said second information includes an identification of another of said mobile computerized device.

34. The method of claim 24, comprising requesting and receiving from said mobile computerized device, via said interface means, at least one of a configuration information and an operational information related to said mobile computerized device or an operation thereof.

35. The method of claim 34, comprising selectively controlling said communication of said at least part of said computer data or computer program to said mobile computerized device on basis of said at least one of a configuration information and an operational information.

36. The method of claim 35, wherein said at least one of a configuration information and an operational information includes at least one of a mobile computerized device type, model, identity geographic location, operational status, external communication type, external communication parameter, an external communications subscription type and an external communications provider.

37. The method of claim 24, wherein said mobile computerized device is a cellular telephone, a personal digital assistant (PDA) or a portable personal computer.

38. The method of claim 37, wherein said mobile computerized device includes an information item including an electronic representation of at least one of a mobile computerized device type, model, identity, geographic location, operational status, external communication type, external communication parameter, an external communications subscription type and an external communications provider, and said information item communicable via an interface of said mobile computerized device corresponding to said interface means.

39. The method of claim 38, wherein said electronic representation of an identity is an IMEI (International Mobile Equipment Identity) of a cellular telephone.
